(19) United States
(12) Patent Application Publication
(10) Pub. No.: US 2011/0267562 A1
(43) Pub. Date: Nov. 3, 2011

(54) LIQUID CRYSTAL PANEL

(76) Inventor: Yuji Yashiro, Osaka (JP)

(21) Appl. No.: 13/144,444

(22) PCT Filed: Dec. 8, 2009
(86) PCT No.: PCT/JP2009/070537

§ 371 Date: Jul. 13, 2011

(30) Foreign Application Priority Data
Apr. 17, 2009 (JP) 2009-101301

(51) Int. Cl. G02F 1/1335

(52) U.S. Cl. 349/62

(57) ABSTRACT

Provided are a first light-transmitting substrate (10) on which a plurality of silicon photodiodes (17) and a plurality of thin-film transistors (16) serving as switching elements for liquid crystal driving are formed, a second light-transmitting substrate (20), and a liquid crystal layer (19) sealed therebetween. A diffraction grating (35 or 36) is formed on a face of a photoreception portion (30) of the silicon photodiodes, the face being on the second light-transmitting substrate side or the side opposite the second light-transmitting substrate. This enables providing a liquid crystal panel including photosensor functionality with improved photodetection sensitivity.

### TECHNICAL FIELD

The present invention relates to a liquid crystal panel, and in particular to a liquid crystal panel including photosensor functionality.

### BACKGROUND ART

PTL 1 discloses a liquid crystal display device with a touch sensor that includes a plurality of display portions and a plurality of photosensor portions. Each of the display portions includes thin-film transistors for pixel switching and pixel electrodes. Each of the photosensor portions is made up of a thin-film diode and is disposed adjacent to a corresponding display portion. Alight shielding layer is provided on the backlight side of the thin-film diodes.

Such a configuration enables realizing a liquid crystal display device with a touch sensor that detects external light incident on the thin-film diodes.

### CITATION LIST

### Patent Literature

PTL 1: WO 2008/132862

### DISCLOSURE OF INVENTION

### Problem to be Solved by the Invention

However, the configuration disclosed in PTL 1 described above has the problem of low photodetection sensitivity since part of the light incident on photoreception portions of the thin-film diodes passes through the thin-film diodes.

An object of the present invention is to provide a liquid crystal panel including photosensor functionality with improved photodetection sensitivity.

### Means for Solving Problem

A liquid crystal panel of the present invention includes: a first light-transmitting substrate on which a plurality of silicon photodiodes and a plurality of thin-film transistors serving as switching elements for liquid crystal driving are formed, a second light-transmitting substrate opposing a face of the first light-transmitting substrate on which the plurality of thin-film transistors and the plurality of silicon photodiodes are formed, and a liquid crystal layer sealed between the first light-transmitting substrate and the second light-transmitting substrate. A diffraction grating is formed on a face of a photoreception portion of each of the silicon photodiodes, the face being on a second light-transmitting substrate side or on a side opposite the second light-transmitting substrate.

### Effects of the Invention

According to the present invention, it is possible to generate diffracted light in the photoreception portion using the diffraction grating. This enables reducing the amount of light that passes through the face of the photoreception portion on the second light-transmitting substrate side and the face on the side opposite the second light-transmitting substrate and exits the photoreception portion, thus making it possible to increase the amount of light detected and improve photodetection sensitivity.

On the other hand, diffracted light generated by light incident on the photoreception portion of the silicon photodiode at a high angle of incidence readily passes through the face of the photoreception portion on the second light-transmitting substrate side and the face on the side opposite the second light-transmitting substrate. This enables easily realizing a touch sensor with high precision in touch position detection.

### BRIEF DESCRIPTION OF DRAWINGS

FIG. 1 is a cross-sectional diagram showing the schematic configuration of a liquid crystal display device with a touch sensor including a liquid crystal panel according to an embodiment of the present invention.

FIG. 2 is an enlarged cross-sectional diagram showing an example of a photoreception portion of a silicon photodiode in the liquid crystal panel according to the embodiment of the present invention.

FIG. 3 is an enlarged cross-sectional diagram showing another example of the photoreception portion of the silicon photodiode in the liquid crystal panel according to the embodiment of the present invention.

FIG. 4A is a cross-sectional diagram showing a step in a method of forming a thin-film transistor and the silicon photodiode on the first light-transmitting substrate.

FIG. 4B is a cross-sectional diagram showing a step in the method of forming the thin-film transistor and the silicon photodiode on the first light-transmitting substrate.

FIG. 4C is a cross-sectional diagram showing a step in the method of forming the thin-film transistor and the silicon photodiode on the first light-transmitting substrate.

FIG. 4D is a cross-sectional diagram showing a step in the method of forming the thin-film transistor and the silicon photodiode on the first light-transmitting substrate.

FIG. 4E is a cross-sectional diagram showing a step in the method of forming the thin-film transistor and the silicon photodiode on the first light-transmitting substrate.

FIG. 4F is a cross-sectional diagram showing a step in the method of forming the thin-film transistor and the silicon photodiode on the first light-transmitting substrate.

FIG. 4G is a cross-sectional diagram showing a step in the method of forming the thin-film transistor and the silicon photodiode on the first light-transmitting substrate.

FIG. 4H is a cross-sectional diagram showing a step in the method of forming the thin-film transistor and the silicon photodiode on the first light-transmitting substrate.

FIG. 4I is a cross-sectional diagram showing a step in the method of forming the thin-film transistor and the silicon photodiode on the first light-transmitting substrate.

FIG. 5 is a circuit diagram of an example of a photosensor portion including the silicon photodiode in the liquid crystal panel according to the embodiment of the present invention.

FIG. 6 is a plan view schematically showing the disposition of thin-film transistors, a silicon photodiode, and the like on the first light-transmitting substrate in the liquid crystal panel according to the embodiment of the present invention.

### DESCRIPTION OF THE INVENTION

In a liquid crystal panel of the present invention, a plurality of thin-film transistors serving as switching elements for liquid crystal driving are formed on a first light-transmitting substrate, and a plurality of silicon photodiodes are further formed on the first light-transmitting substrate. With the exception of the configuration related to the silicon photodiode, there are no particular limitations on the configuration of the liquid crystal panel, and it is possible to employ, for example, the same configuration as that of a known liquid crystal panel.

The silicon photodiodes may be composed of amorphous silicon (a-Si) or polysilicon (p-Si). With the exception of the diffraction grating, there are no particular limitations on the basic configuration of the silicon photodiodes.

A diffraction grating is formed on the interface between the photoreception portion of each silicon photodiode and a layer adjacent to the photoreception portion. Accordingly, when light is incident on the face on which the diffraction grating is formed, diffracted light is generated in the photoreception portion.

It is preferable that letting n1 be a refractive index of a first layer adjacent to the photoreception portion on the second light-transmitting substrate side, n2 be a refractive index of the photoreception portion, n3 be a refractive index of a second layer adjacent to the photoreception portion on the side opposite the second light-transmitting substrate, λ be a wavelength of a light beam incident from the first layer onto the photoreception portion, θ1 be an angle of incidence of the light beam incident from the first layer onto the photoreception portion, θ2 be an angle of emergence of diffracted light of the light beam exiting from the face on which the diffraction grating is formed into the photoreception portion, m be a diffraction order of the diffracted light, and d be a structural period of the diffraction grating, the structural period d is set such that

when |m|=1,

n2*sin θ2=n1*sin θ1+m*(λ/d),

θ2>arksin (n1/n2) and

θ2>arksin (n3/n2)

are satisfied. Accordingly, +1-order diffracted light and/or −1-order diffracted light generated in the photoreception portion undergoes total reflection at the interface between the photoreception portion and the first layer and at the interface between the photoreception portion and the second layer, and propagates within the photoreception portion. Photodetection sensitivity is therefore further improved.

In this case, it is preferable that a touch sensor face is provided on a side of the second light-transmitting substrate opposite the first light-transmitting substrate, and letting H be a gap between the photoreception portion and the touch sensor face, and W be a pixel pitch in a repeating direction of the periodic structure of the diffraction grating,

θ1<arktan (W/H)

is satisfied. Accordingly, the detectable range of the silicon photodiode decreases, thus enabling further improving precision in touch position detection.

It is preferable that letting n1 be a refractive index of a first layer adjacent to the photoreception portion on the second light-transmitting substrate side, n2 be a refractive index of the photoreception portion, λ be a wavelength of a light beam incident from the first layer onto the photoreception portion, θ1 be an angle of incidence of the light beam incident from the first layer onto the photoreception portion, θ2 be an angle of emergence of diffracted light of the light beam exiting from the face on which the diffraction grating is formed into the photoreception portion, m be a diffraction order of the diffracted light, and d be a structural period of the diffraction grating,

when |m|>1,

n2*sin θ2=n1*sin θ1+m*(λ/d),

sin θ2>1 or sin θ2<−1

are satisfied. Accordingly, high-order diffracted light that is ±2-order or higher is not generated in the photoreception portion. The amount of light that exits from the photoreception portion into the first layer or the second layer therefore decreases, thus further improving the photodetection sensitivity.

Below, a detailed description of the present invention is given using a preferred embodiment. Note that the present invention is, needless to say, not limited to the below embodiment.

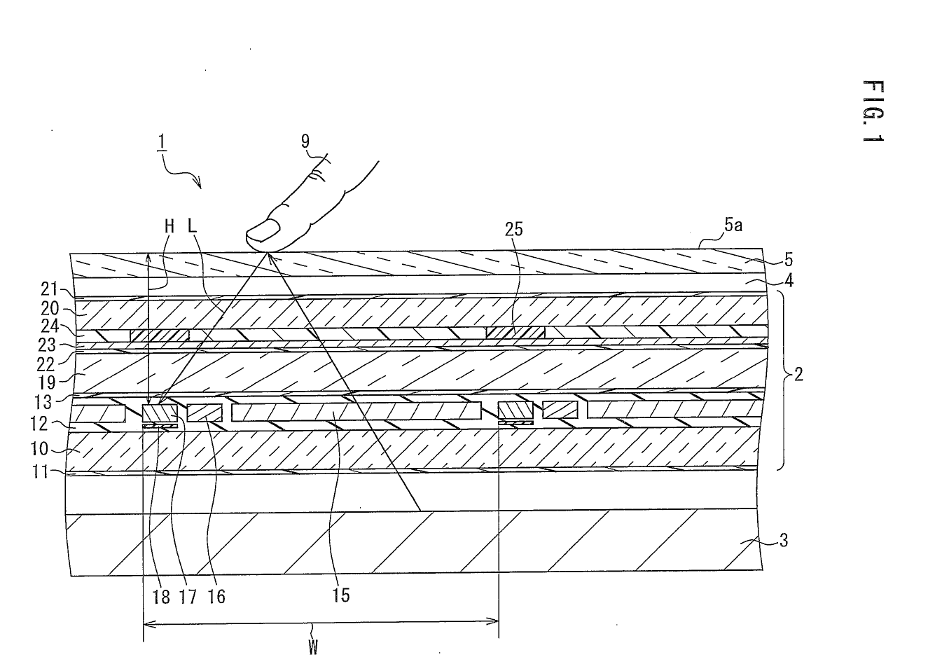

FIG. 1 is a cross-sectional diagram showing the schematic configuration of a liquid crystal display device 1 with a touch sensor that includes a liquid crystal panel 2 according to an embodiment of the present invention.

The liquid crystal display device 1 further includes an illumination device 3 that illuminates the back face of the liquid crystal panel 2, and a light-transmitting protective panel 5 arranged separated from the liquid crystal panel 2 via an air gap 4.

The liquid crystal panel 2 includes a first light-transmitting substrate 10 and a second light-transmitting substrate 20 that are both plate-shaped members, and a liquid crystal layer 19 sealed therebetween. There are no particular limitations on the material of the first and second light-transmitting substrates 10 and 20, and it is possible to use, for example, the same materials used in a conventional liquid crystal panel, such as glass or an acrylic resin.

A deflection plate 11 that transmits or absorbs a specified polarization component is laminated on the face of the first light-transmitting substrate 10 on the illumination device 3 side. An insulating layer 12 and an alignment film 13 are laminated in the stated order on the face of the first light-transmitting substrate 10 on the side opposite the deflection plate 11. The alignment film 13 is a layer for aligning liquid crystal, and is configured by an organic thin film composed of a polyimide or the like. Formed in the insulating layer 12 are a pixel electrode 15 made up of a transparent conductive thin film composed of ITO or the like, a thin-film transistor (TFT) 16 that is connected to the pixel electrode 15 and serves as a switching element for liquid crystal driving, and a silicon photodiode 17 that has photosensor functionality. A light shielding layer 18 is formed on the illumination device 3 side of the silicon photodiode 17.

A polarizing plate 21 that transmits or absorbs a specified polarization component is laminated on the face of the second light-transmitting substrate 20 on the side opposite the liquid crystal layer 19. An alignment film 22, a common electrode 23, and color filters 24/black matrices 25 are formed on the face of the second light-transmitting substrate 20 on the liquid crystal layer 19 side, in the stated order beginning from the liquid crystal layer 19 side. Similarly to the alignment film 13 provided on the first light-transmitting substrate 10, the alignment film 22 is a layer for aligning liquid crystal, and is configured by an organic thin film composed of a polyimide or the like. The common electrode 23 is made up of a transparent conductive thin film composed of ITO or the like. The color filters 24 are made up of three types of resin films that selectively transmit light in the wavelength bands of the three primary colors red (R), green (G), and blue (B). The black matrices 25 are light shielding films disposed between adjacent color filters 24.

With the liquid crystal panel 2 of the present embodiment, one pixel electrode 15 and one thin-film transistor 16 are disposed with respect to one color filter 24 of any one of the primary colors red, green, and blue, thus configuring a primary color pixel. One silicon photodiode 17 and one light shielding layer 18 are disposed with respect to three primary color pixels, namely red, green, and blue, thus configuring a color pixel. Such color pixels are regularly disposed vertically and horizontally.

The light-transmitting protective panel 5 is made up of a flat plate composed of glass, an acrylic resin, or the like. The face of the light-transmitting protective panel 5 on the side opposite the liquid crystal panel 2 is a touch sensor face 5a that can be touched by a human finger 9. Providing the light-transmitting protective panel 5 separated from the liquid crystal panel 2 by the air gap 4 prevents the force of the human finger 9 pressing on the light-transmitting protective panel 5 from being transmitted to the liquid crystal panel 2, thus preventing an undesired rippling pattern from appearing on the display screen due to the pressing force of the finger 9.

There are no particular limitations on the illumination device 3, and a known illumination device can be used as the illumination device of the liquid crystal panel. For example, a direct-type or edge light-type illumination device can be used, and in particular, an edge light-type illumination device is preferable due to being advantageous in reducing the thickness of the liquid crystal display device. Also, any type of light source may be used, examples of which include a cold/hot cathode tube and an LED.

The liquid crystal display device 1 of the present embodiment has an image display function for displaying a color image by allowing light from the illumination device 3 to pass through the liquid crystal panel 2 and the light-transmitting protective panel 5. The liquid crystal display device 1 further includes a touch sensor function for detecting the position of the finger 9 that has touched the touch sensor face 5a of the light-transmitting protective panel 5. The touch sensor function is realized as described below. Specifically, light from the illumination device 3 is reflected in the region where the finger 9 has come into contact with the touch sensor face 5a of the light-transmitting protective panel 5. Such reflected light L again passes through a color filter 24 of the liquid crystal panel 2 and is incident on a silicon photodiode 17. The reflected light L generated by the finger 9 touching the touch sensor face 5a in this way is detected by the silicon photodiode 17, thus detecting the contact position of the finger 9. Disposing one silicon photodiode 17 with respect to one color pixel enables detecting whether the finger 9 has come into contact in the region of that color pixel, thus making it possible to perform touch position detection with high resolution.

In order to allow more light to reach the silicon photodiode 17, it is preferable that infrared light having a long wavelength is used. Accordingly, it is preferable that the illumination device 3 is provided with a light source that emits infrared light (e.g., a light source (such as an LED) that has a peak wavelength in the vicinity of 900 nm). Also, with respect to light that exits the illumination device 3, is then reflected at the touch sensor face 5a of the light-transmitting protective panel 5, and then incident on the silicon photodiode 17, it is preferable that the silicon photodiode 17 is disposed such that such light passes through the red color filter 24.

The light shielding layer 18 is provided in order to prevent light from the illumination device 3 from being incident directly on the silicon photodiode 17 without being reflected at the touch sensor face 5a.

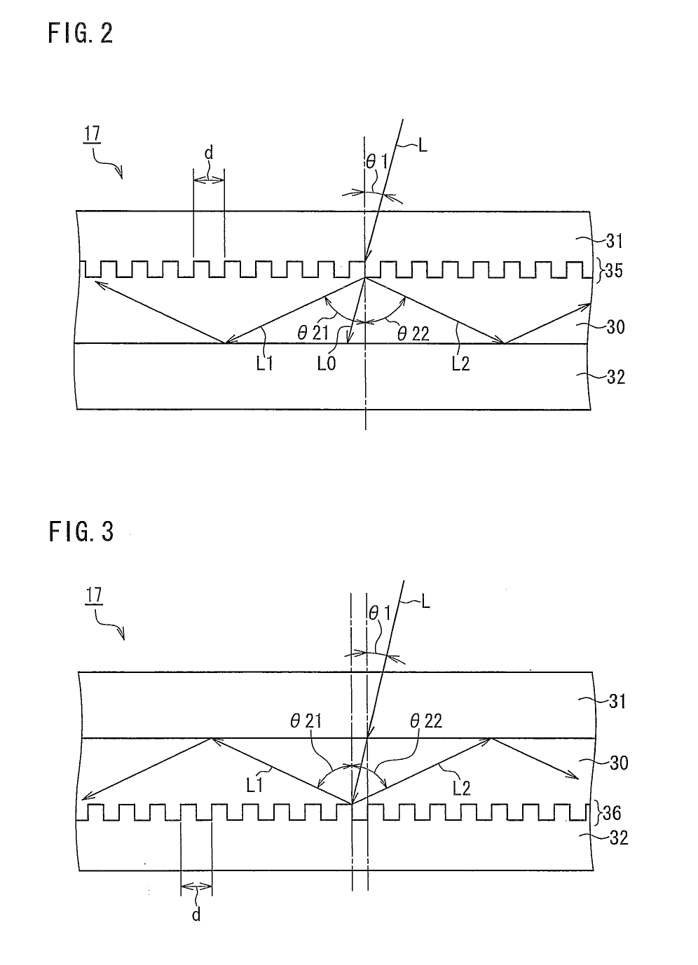

FIG. 2 is an enlarged cross-sectional diagram showing an example of a photoreception portion of the silicon photodiode 17. In FIG. 2, 30 denotes the photoreception portion (e.g., the intrinsic region) of the silicon photodiode 17. A first layer 31 serving as an insulating layer is adjacent to the face of the photoreception portion 30 on the liquid crystal layer 19 side (the upper side in FIG. 2), and a second layer 32 serving as an insulating layer is adjacent to the face of the photoreception portion 30 on the illumination device 3 side (the upper side in FIG. 2). Also, a diffraction grating 35 is formed on the face of the photoreception portion 30 on the first layer 31 side (i.e., the interface between the photoreception portion 30 and the first layer 31).

Effects of the diffraction grating 35 are described below.

The light L (see FIG. 1) that has been reflected in the region of contact between the finger 9 and the touch sensor face 5a of the light-transmitting protective panel 5 is incident from the first layer 31 onto the interface between the first layer 31 and the photoreception portion 30 at an angle of incidence θ1. When passing through the interface, the light L is diffracted by the diffraction grating 35 formed on the interface, thus generating 0-order light L0, +1-order diffracted light L1, and −1-order diffracted light L2. Let θ21 be the angle of emergence of the +1-order diffracted light L1, and θ22 be the angle of emergence of the −1-order diffracted light L2. The +1-order diffracted light L1 and the −1-order diffracted light L2 are reflected at the interface between the photoreception portion 30 and the first layer 31 and at the interface between the photoreception portion 30 and the second layer 32, propagate with the photoreception portion 30 serving as a light guiding layer, and are absorbed and detected within the photoreception portion 30. In this way, with respect to light that has been incident on the photoreception portion 30, the amount of such light that exits the photoreception portion 30 can be reduced, thus improving the photodetection sensitivity of the silicon photodiode 17.

In order to further improve the photodetection sensitivity of the silicon photodiode 17, it is preferable that the +1-order diffracted light L1 and the −1-order diffracted light L2 undergo total reflection at the interface between the photoreception portion 30 and the first layer 31 and at the interface between the photoreception portion 30 and the second layer 32. The following describes conditions for realizing this.

Letting n1 be the refractive index of the first layer 31, n2 be the refractive index of the photoreception portion 30, n3 be the refractive index of the second layer 32, be the wavelength of the light L incident from the first layer 31 onto the photoreception portion 30, θ1 be the angle of incidence of the light L incident from the first layer 31 onto the photoreception portion 30, θ2 be the angle of emergence of diffracted light exiting from the face on which the diffraction grating 35 is formed into the photoreception portion 30, m be the diffraction order of the diffracted light, and d be the structural period of the diffraction grating, the diffraction formula of Expression (1) below holds.

n2*sin θ2=n1*sin θ1+m*(λ/d) (1)

In order for the +1-order diffracted light L1 and the −1-order diffracted light L2 to undergo total reflection at the interface between the photoreception portion 30 and the first layer 31 and at the interface between the photoreception portion 30 and the second layer 32, it is necessary that Condition 1 below holds in the above Expression (1).

|m|=1,

θ2>arksin (n1/n2) and

θ2>arksin (n3/n2) [Condition 1]

In other words, when the above Expression (1) holds under the above Condition 1, the +1-order diffracted light L1 and the −1-order diffracted light L2 propagate while undergoing total reflection within the photoreception portion 30.

In FIG. 1, it is preferable that the light L incident on the photoreception portion 30 of the silicon photodiode 17 is light that has twice passed through the color filter 24 that configures the color pixel along with the silicon photodiode 17. If light that is incident on the silicon photodiode 17 is light with a high angle of incidence θ1 that has passed through a color filter 24 not corresponding to that silicon photodiode 17, there is the risk of a reduction in the precision of touch position detection. Accordingly, letting H be the gap between the photoreception portion 30 and the touch sensor face 5a, and W (see FIG. 1) be the pixel pitch in the repeating direction of the periodic structure of the diffraction grating 35 (the horizontal direction of the paper plane in FIG. 2), it is preferable that Condition 2 below is satisfied.

θ1<arktan (W/H) [Condition 2]

Note that even if light that is incident on the silicon photodiode 17 is light with a high angle of incidence θ1 that has passed through a color filter 24 not corresponding to that silicon photodiode 17, the ±1-order diffracted light L1 and L2 are not generated in the photoreception portion 30, or even if the ±1-order diffracted light L1 and L2 are generated, the ±1-order diffracted light L1 and L2 does not have an angle of emergence that enables propagation while undergoing total reflection within the photoreception portion 30. In this way, the silicon photodiode 17 has angular dependence in that the lower the angle of incidence θ1 of light, the higher the precision with which detection can be performed. In other words, the detectable range of the individual silicon photodiodes 17 is relatively small. Therefore, densely disposing the silicon photodiodes 17 enables realizing a touch sensor with high precision in touch position detection.

In FIG. 2, if high-order diffracted light that is +2-order or higher is generated, there is the possibility of part of such high-order diffracted light passing through the interface between the photoreception portion 30 and the first layer 31 or the interface between the photoreception portion 30 and the second layer 32, and the photodetection sensitivity of the silicon photodiodes 17 cannot be improved in such a case. In order to prevent high-order diffracted light that is ±2-order or higher from being generated, it is sufficient for Condition 3 below to hold in the above Expression (1).

|m|>1,

sin θ2>1 or sin θ2<−1 [Condition 3]

A description of a specific working example of the present embodiment will now be given.

In FIG. 2, consider the case where infrared light L with a wavelength λ of 900 nm is incident from the first layer 31 onto the photoreception portion 30 at the angle of incidence θ1. SiO₂ with a refractive index n1 of 1.452 is used as the first layer 31, silicon with a refractive index n2 of 3.67 is used as the photoreception portion 30, and SiN with a refractive index n3 of 1.95 is used as the second layer 32. Here, the values of the refractive indices n1, n2, and n3 are all values with respect to infrared light with a wavelength λ of 900 nm.

In FIG. 1, assume that the gap H between the photoreception portion 30 and the touch sensor face 5a is 1,700 μm, and the pixel pitch W in the repeating direction of the periodic structure of the diffraction grating 35 (the horizontal direction of the paper plane in FIG. 1) is 104 μm. When the finger 9 is at a position on the touch sensor face 5a that is within the region of a color pixel containing a silicon photodiode 17 and is farthest away from a position directly above the silicon photodiode 17 along the repeating direction of the periodic structure of the diffraction grating 35, the angle of incidence θ1 of the light L shown in FIG. 2 is arktan (104/1,700)=3.5°.

The critical angle of light heading from the photoreception portion 30 toward the first layer 31 is arksin (n1/n2)=23.3°, and the critical angle of light heading from the photoreception portion 30 toward the second layer 32 is arksin (n3/n2)=32.1°.

In order for the +1-order diffracted light L1 and the −1-order diffracted light L2 to propagate within the photoreception portion 30, it is sufficient to set the structural period d of the diffraction grating 35 such that the −1-order diffracted light L2, which has the smaller angle of emergence, undergoes total reflection at the interface between the photoreception portion 30 and the second layer 32, which has the higher critical angle. Accordingly, d=441.5 nm when the following is derived using the above Expression (1).

3.67*sin(−32.1°)=1.452*sin(3.5°)±(−1)*(900/d)

Specifically, if the structural period d of the diffraction grating 35 is set such that d<441.5 nm, θ21>35.4° holds for the angle of emergence of the +1-order diffracted light L1, and θ22>|−32.1°| holds for the angle of emergence of the −1-order diffracted light L2, and since both are higher than the critical angle described above, the +1-order diffracted light L1 and the −1-order diffracted light L2 propagate while undergoing total reflection within the photoreception portion 30. Also, if the structural period d is set such that d<441.5 nm, the above Condition 3 is satisfied when |m|>1, and thus ±2-order or higher diffracted light is not generated.

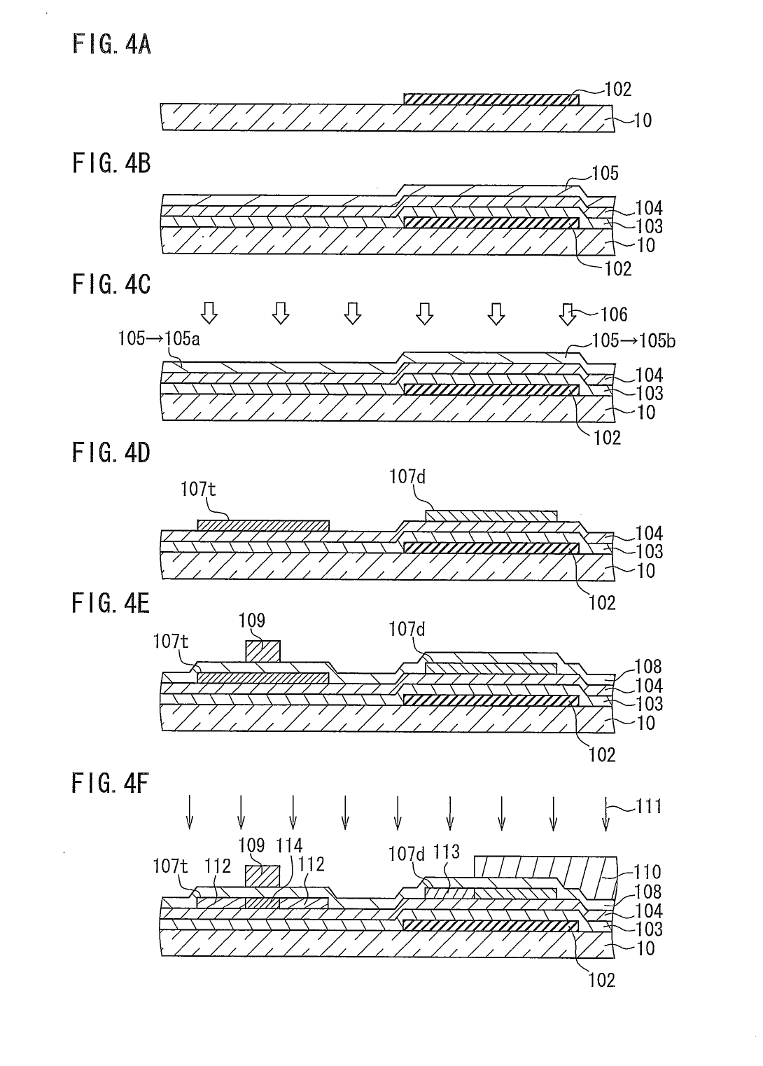

FIG. 3 is an enlarged cross-sectional diagram showing another example of the photoreception portion of the silicon photodiode 17. In FIG. 3, a diffraction grating 36 is formed on the face of the photoreception portion 30 on the second layer 32 side (i.e., the interface between the photoreception portion 30 and the second layer 32), which is a difference from FIG. 2 in which the diffraction grating 35 is formed on the face of the photoreception portion 30 on the first layer 31 side. The other aspects of FIG. 3 are the same as in FIG. 2, and constituent elements that are the same as those in FIG. 2 have been given the same reference signs and will not be described.

Effects of the diffraction grating 36 are described below.

Light L (see FIG. 1) that has been reflected in the region of contact between the finger 9 and the light-transmitting protective panel 5 is incident from the first layer 31 onto the interface between the first layer 31 and the photoreception portion 30 at the angle of incidence θ1. The light L is refracted at that interface and then is incident on the interface between the photoreception portion 30 and the second layer 32. When the light L is reflected at the interface between the photoreception portion 30 and the second layer 32, it is diffracted by the diffraction grating 36 formed on that interface, and the +1-order diffracted light L1 and the −1-order diffracted light L2 are generated. Let θ21 be the angle of emergence of the +1-order diffracted light L1, and θ22 be the angle of emergence of the −1-order diffracted light L2. The +1-order diffracted light L1 and the −1-order diffracted light L2 are reflected at the interface between the photoreception portion 30 and the first layer 31 and at the interface between the photoreception portion 30 and the second layer 32, propagate with the photoreception portion 30 serving as a light guiding layer, and are absorbed and detected within the photoreception portion 30. As a result, the photodetection sensitivity of the silicon photodiode 17 improves.

As shown in FIG. 3, let n1 be the refractive index of the first layer 31, n2 be the refractive index of the photoreception portion 30, n3 be the refractive index of the second layer 32, λ be the wavelength of the light L incident from the first layer 31 onto the photoreception portion 30, θ1 be the angle of incidence of the light L incident from the first layer 31 onto the photoreception portion 30, θ2 be the angle of emergence of diffracted light exiting from the face on which the diffraction grating 36 is formed into the photoreception portion 30, m be the diffraction order of the diffracted light, and d be the structural period of the diffraction grating. When Snell's law is applied since the photoreception portion 30 is a parallel plate, the diffraction formula of the below Expression (1) described in FIG. 2 similarly holds in FIG. 3 as well.

n2*sin θ2=n1*sin θ1+m*(λ/d) (1)

Accordingly, the Conditions 1 to 3, the effects thereof, and the working example described in the configuration shown in FIG. 2 can be similarly applied also to the configuration shown in FIG. 3.

Next is a description of a method of forming the thin-film transistor 16 and the silicon photodiode 17 on the first light-transmitting substrate 10, along with a working example. Note that the method described below is merely an example, and formation by a method other than that described below is of course possible.

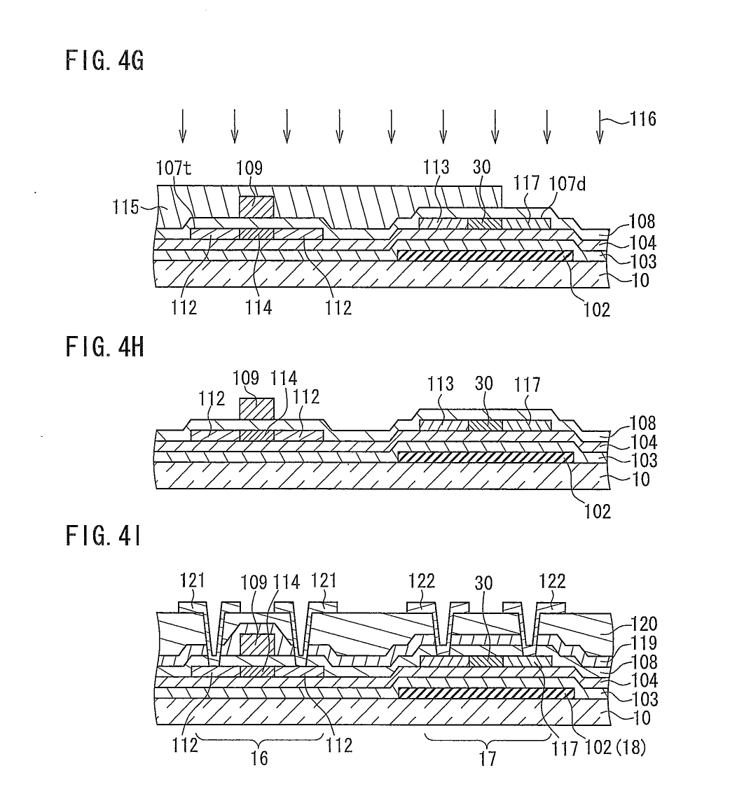

Firstly, the first light-transmitting substrate 10 is prepared as shown in FIG. 4A. A low-alkali glass substrate, a quartz substrate, or the like can be used as the substrate 10. In the working example, a low-alkali glass substrate was used. In this case, the substrate 10 may be heated in advance to a temperature approximately 10° C. to 20° C. lower than the glass strain point. A heat sink layer 102 that functions as a heat sink in the later laser irradiation step is provided on one surface of the substrate 10. If a film having light shielding characteristics is employed as the heat sink layer 102, the heat sink layer 102 can be caused to function as the light shielding layer 18 (see FIG. 1) for shielding the silicon photodiode 17. A metal film, a silicon film, or the like can be used as the heat sink layer 102. In the case of using a metal film, it is preferable that tantalum (Ta), tungsten (W), molybdenum (Mo), or the like, which are high melting point metals, is used in consideration of the heating performed in later manufacturing steps.

In the working example, the heat sink layer 102 was formed by forming a Mo film by sputtering, and then performing patterning. Here, the thickness of the heat sink layer 102 is 20 nm to 200 nm, or more preferably 30 nm to 150 nm, and was 100 nm in the working example.

Next, as shown in FIG. 4B, an underlying film such as a silicon oxide film, a silicon nitride film, or a silicon oxynitride film is formed in order to prevent the diffusion of impurities from the substrate 10. In the working example, a plasma CVD method was used to form a silicon oxynitride film as a first underlying film 103 from the material gases SiH₄, NH₃, and N₂O, and a plasma CVD method was similarly used to form a silicon oxide film on the first underlying film 103 as a second underlying film 104 from the material gases SiH₄ and N₂O. The total thickness of the first underlying film 103 and the second underlying film 104 is 100 nm to 600 nm, or more preferably 150 nm to 450 nm, and it is preferable that the thickness of the first underlying film 103 is 50 nm to 400 nm, and that the thickness of the second underlying film 104 is 30 nm to 300 nm. In the working example, the thickness of the first underlying film 103 was 200 nm, and the thickness of the second underlying film 104 was 150 nm. Although an underlying film having a two-layer configuration is formed in the present embodiment, a single-layer underlying film made up of a silicon oxide film or the like may be used.

In the case where the diffraction grating 36 is formed on the lower face of the photoreception portion 30 as shown in FIG. 3, a diffraction grating structure is formed on the upper face of the second underlying film 104 by forming a photoresist having a predetermined pattern on the surface of the second underlying film 104 in the region above the heat sink layer 102, and then performing etching.

Next, a silicon film (a-Si film) 105 having an amorphous structure and having a thickness of 20 nm to 150 nm (preferably 30 nm to 80 nm) is formed using a known method such as a plasma CVD method or a sputtering method. In the working example, the amorphous silicon film was formed to a thickness of 50 nm using a plasma CVD method. Since the underlying films 103 and 104 and the amorphous silicon film 105 can be formed using the same film formation method, they may be formed consecutively. After the underlying film is formed, contamination of the surface thereof can be prevented by temporarily not allowing exposure to the atmosphere, thus enabling reducing variation in characteristics and fluctuation in the threshold voltage of the TFTs that are manufactured.

Next, as shown in FIG. 4C, the amorphous silicon film 105 is crystallized by irradiating it with laser light 106. A XeCl excimer laser (with a wavelength of 308 nm and a pulse width of 40 nsec), a KrF excimer laser (with a wavelength of 248 nm), or the like can be used to emit such laser light. The beam size of the laser light is set so as to have an elongated shape on the surface of the substrate 10, and the entire face of the substrate is crystallized by successively scanning the laser light in the direction perpendicular to the elongated direction. The amorphous silicon film 105 instantaneously melts due to the laser irradiation, and then crystallizes in the solidification process. Note that with the amorphous silicon film 105, the escape of heat is faster and the speed of solidification is faster in the region above the heat sink layer 102, compared to the region not including the heat sink layer 102. For this reason, a difference in crystallinity appears between a crystalline silicon region 105b formed by crystallization over the heat sink layer 102 and a crystalline silicon region 105a formed by crystallization in the region not including the heat sink layer 102.

Thereafter, the elements are separated by removing unnecessary regions of the crystalline silicon regions 105a and 105b. Specifically, as shown in FIG. 4I), an island-shaped semiconductor layer 107t that is to later serve as an active region of the TFT (a source/drain region or a channel region) is formed using the crystalline silicon region 105a, and an island-shaped semiconductor layer 107d that is to later serve as an active region of the silicon photodiode (an n⁺/p⁺ region or an intrinsic region) is formed using the crystalline silicon region 105b.

In the case where the diffraction grating 35 is formed on the upper face of the photoreception portion 30 as shown in FIG. 2, a diffraction grating structure is formed on the upper face of the semiconductor layer 107d by forming a photoresist having a predetermined pattern on the upper face of the semiconductor layer 107d, and then performing etching.

Next, as shown in FIG. 4E, a gate insulating film 108 that covers the island-shaped semiconductor layers 107t and 107d is formed. It is preferable that a 20-nm to 150-nm thick silicon oxide film is used as the gate insulating film 108, and a 100-nm silicon oxide film was used in the working example.

Next, a conductive film is deposited on the gate insulating film 108 using a sputtering method, a CVD method, or the like, and then patterning is performed, thus forming a TFT gate electrode 109. At this time, the conductive film is not formed on the island-shaped semiconductor layer 107d. It is desirable that the material of the conductive film is any of the high melting point metals W, Ta, Ti, and Mo, or an alloy thereof. Also, it is desirable that the film thickness of the conductive film is 300 nm to 600 nm. In the working example, a conductive film having a film thickness of 450 nm was formed using tantalum (Ta) to which a trace amount of nitrogen was added.

Next, as shown in FIG. 4F, a mask 110 made up of a resist is formed on the gate insulating film 108 so as to cover part of the island-shaped semiconductor layer 107d. Then, in this state, ion doping is performed over the entire face from above the substrate 101 using an n-type impurity (phosphorus) 111. The ion doping with the phosphorus 111 is performed such that the phosphorus 111 passes through the gate insulating film 108 and is implanted in the semiconductor layers 107t and 107d. According to this step, the phosphorus 111 is implanted in the region of the semiconductor layer 107d not covered by the resist mask 110 and in the region of the semiconductor layer 107t not covered by the gate electrode 109. The regions covered by the resist mask 110 or the gate electrode 109 are not doped with the phosphorus 111. Accordingly, the region of the semiconductor layer 107t implanted with the phosphorus 111 later serves as a source region and drain region 112 of the TFT, and the region not implanted with the phosphorus 111 due to being masked by the gate electrode 109 later serves as a channel region 114 of the WT. Also, the region of the semiconductor layer 107d implanted with the phosphorus 111 later serves as an n⁺ region 113 of the silicon photodiode.

Next, the resist mask 110 is removed, and thereafter as shown in FIG. 4G, a mask 115 made up of a resist is formed on the gate insulating film 108 so as to cover the part of the semiconductor layer 107d that is to later serve as the active region of the silicon photodiode and cover the entire region of the semiconductor layer 107t that is to later serve as the active region of the TFT. Then, in this state, ion doping is performed over the entire face from above the substrate 101 using a p-type impurity (boron) 116. The ion doping with the boron 116 is performed such that the boron 116 passes through the gate insulating film 108 and is implanted in the semiconductor layer 107d. According to this step, the boron 116 is implanted in the region of the semiconductor layer 107d not covered by the resist mask 115. The region covered by the mask 115 is not doped with the boron 116. Accordingly, the region of the semiconductor layer 107d implanted with the boron 116 later serves as a p⁺ region 117 of the silicon photodiode, and the region not implanted with the boron 116 and furthermore not implanted with the phosphorus 111 in the previous step later serves as the intrinsic region (photoreception portion) 30.

Next, the resist mask 115 is removed, and thereafter heating is performed in an inert atmosphere, such as a nitrogen atmosphere. As shown in FIG. 4H, this heating repairs doping damage such as crystal defects that appeared during doping in the source/drain region 112 of the TFT and the n⁺ region 113 and the p⁺ region 117 of the silicon photodiode, and activates the phosphorus and boron respectively doped therein. This enables reducing the resistance of the source/drain region 112, the n⁺ region 113, and the p⁺ region 117. Although a general furnace may be used for the heating, it is more desirable that RTA (Rapid Thermal Annealing) is used. In particular, performing heating using a method of instantaneously raising/lowering the temperature by blowing a high-temperature inert gas on the substrate surface is suitable.

Next, as shown in FIG. 4I, a silicon oxide film or a silicon nitride film is formed as an interlayer insulating film. In the working example, an interlayer insulating film having a two-layer structure including a silicon nitride film 119 and a silicon oxide film 120 was formed. Thereafter, contact holes are formed, and an electrode/wire 121 for the TFT and an electrode/wire 122 for the silicon photodiode are formed using a metal material.

Lastly, annealing is performed at 350° C. to 450° C. in a nitrogen atmosphere or a hydrogen mixture atmosphere at 1 atmosphere, thus completing the thin-film transistor (TFT) 16 and the silicon photodiode 17 shown in FIG. 4I. Furthermore, a protective film made up of a silicon nitride film or the like may, as necessary, be provided on the thin-film transistor 16 and the silicon photodiode 17 for the protection thereof. As described above, the heat sink layer 102 can be used as the light shielding film 18.

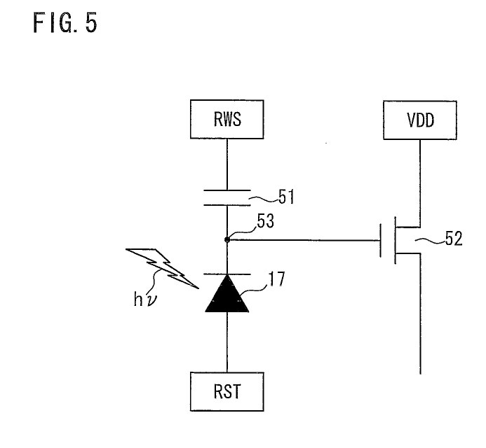

FIG. 5 is a circuit diagram showing an example of a photosensor portion including the silicon photodiode 17. The photosensor portion has the silicon photodiode 17, a signal accumulation capacitor 51, and a thin-film transistor 52 for retrieving a signal accumulated in the capacitor 51. When an RST signal is input, an RST potential is written to a node 53, and thereafter the potential of the node 53 decreases due to leaking caused by light, the gate potential of the thin-film transistor 52 fluctuates and the gate opens and closes. This enables retrieving a signal VDD.

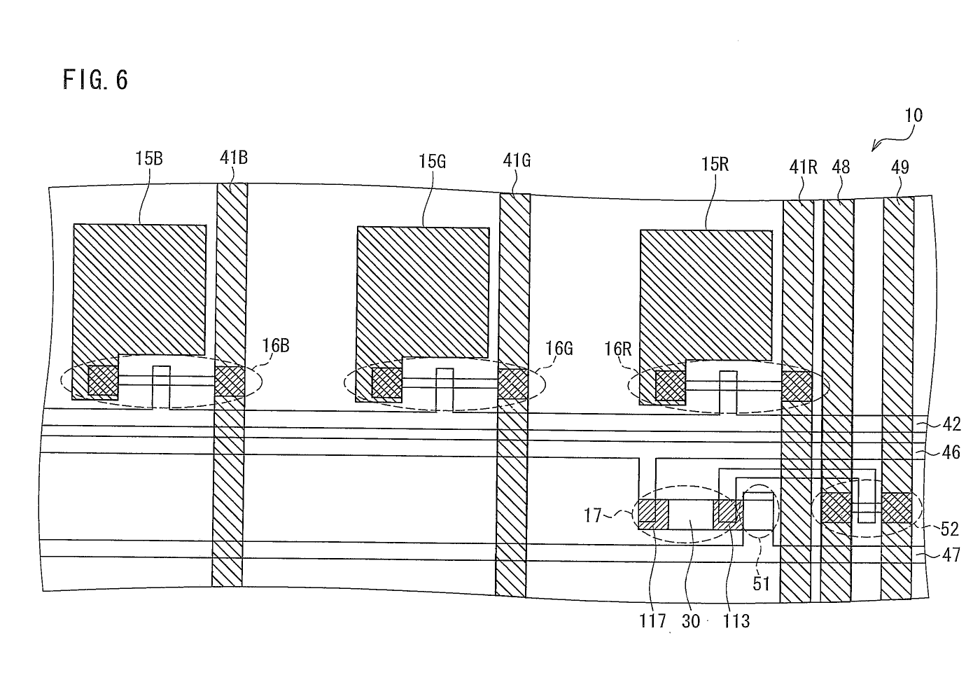

FIG. 6 is a plan view of the first light-transmitting substrate 10. FIG. 6 shows only the three red, green, and blue primary color pixels. Many color pixels each made up of these three primary color pixels are disposed vertically and horizontally. In FIG. 6, R, G, or B has been appended to the reference signs denoting members provided in correspondence with the colors red, green, and blue.

A display portion made up of pixel electrodes 15R, 15G, and 15B and thin-film transistors 16R, 16G, and 16B for switching is provided on the first light-transmitting substrate 10. The red primary color pixel is furthermore provided with the photosensor portion that includes the silicon photodiode 17, the signal accumulation capacitor 51, and the photosensor follower thin-film transistor 52.

The source regions of the thin-film transistors 16R, 16G, and 16B are connected to pixel source bus lines 41R, 41G, and 41B, and the drain regions are connected to the pixel electrodes 15R, 15G, and 15B. The thin-film transistors 16R, 16G, and 16B are turned on and off according to a signal from a pixel gate bus line 42. Accordingly, voltages are applied to the liquid crystal layer 19 by the pixel electrodes 15R, 15G, and 15B and the common electrode 23 (see FIG. 1) formed on the second light-transmitting substrate 20 that is disposed opposing the first light-transmitting substrate 10, and the oriented state of the liquid crystal layer 19 is changed, thus displaying an image.

The silicon photodiode 17 includes the p⁺ region 117, the n⁺ region 113, and the intrinsic region (photoreception portion) 30 located between the regions 117 and 113. In the signal accumulation capacitor 51, a gate electrode layer and a Si layer serve as electrodes, and a capacitance is formed in a gate insulating film. The p⁺ region 117 of the silicon photodiode 17 is connected to a photosensor RST signal line 46, and the n⁺ region 113 is connected to the bottom electrode (Si layer) of the signal accumulation capacitor 51, and to a photosensor RWS signal line 47 via the capacitor 51. Furthermore, the n⁺ region 113 is connected to the gate electrode layer of the photosensor follower thin-film transistor 52. The source and drain regions of the photosensor follower thin-film transistor 52 are connected to a photosensor VDD signal line 48 and a photosensor COL signal line 49 respectively. The repeating direction of the periodic structure of the diffraction grating provided in the photoreception portion 30 of the silicon photodiode coincides with the vertical direction of the paper plane in FIG. 6.

The following describes operations during optical sensing performed by a drive circuit of the photosensor portion including the silicon photodiode 17, the signal accumulation capacitor 51, and the photosensor follower thin-film transistor 52 configured as described above.

(1) Firstly, an RWS signal is written to the signal accumulation capacitor 51 via the RWS signal line 47. Accordingly, a positive electric field is generated in the silicon photodiode 17 on the n⁺ region 113 side, and the silicon photodiode 17 becomes reverse-biased. (2) When light is incident on the intrinsic region (photoreception portion) 30 of the silicon photodiode 17, light leakage occurs and charge escapes to the RST signal line 46 side. (3) Accordingly, the potential on the n⁺ region 113 side decreases, and the gate voltage applied to the photosensor follower thin-film transistor 52 changes due to the change in potential. (4) A VDD signal is applied to the source side of the photosensor follower thin-film transistor 52 via the VDD signal line 48. When the gate voltage changes as described above, the value of the current flowing to the COL signal line 49 connected to the drain side changes, thus enabling that electrical signal to be retrieved from the COL signal line 49. (5) An RST signal is written from the COL signal line 49 to the silicon photodiode 17, and the potential of the signal accumulation capacitor 51 is reset. Repeating the operations of (1) to (5) described above while scanning enables performing optical sensing.

The configuration of the first light-transmitting substrate 10 of the liquid crystal panel of the present invention is not limited to FIG. 6. For example, the thin-film transistor for switching may be provided with an auxiliary capacitor (Cs). Although the photosensor portion is provided in only the red primary color pixel in FIG. 6, the three red, green, and blue primary color pixels may each be provided with the photosensor portion. Alternatively, one photosensor portion may be provided with respect to a plurality of color pixels.

Although the example of detecting the contact position of a finger is described in the above embodiment, it is also possible to detect the contact position of, besides a finger, an input pen or the like.

Although the light-transmitting protective panel is provided separated from the liquid crystal panel via an air gap in the embodiment described above, the air gap may be omitted. The light-transmitting protective panel may also be omitted.

Although a liquid crystal panel that displays a color image is described in the embodiment described above, the present invention is also applicable to a liquid crystal panel that displays a monochrome image.

### INDUSTRIAL APPLICABILITY

There are no particular limitations on the field of the present invention, and the present invention can be used in a wide range as, for example, a liquid crystal display device including a touch sensor function. For example, the present invention can be used in a device for both display and input in various types of devices, such as the display screen of a mobile phone, a PDA (Personal Digital Assistant), or a portable gaming device, or the operation screen of a digital camera monitor, an ATM (Automated Teller Machine), or the like.

### REFERENCE SIGNS

1 liquid crystal display device
2 liquid crystal panel
3 illumination device
4 air gap
5 light-transmitting protective panel
5a touch sensor face
9 finger
10 first light-transmitting substrate
15 pixel electrode
16 thin-film transistor
17 silicon photodiode
19 liquid crystal layer
20 second light-transmitting substrate
30 photoreception portion of silicon photodiode
31 first layer
32 second layer
35, 36 diffraction grating

1. A liquid crystal panel comprising a first light-transmitting substrate on which a plurality of silicon photodiodes and a plurality of thin-film transistors serving as switching elements for liquid crystal driving are formed, a second light-transmitting substrate opposing a face of the first light-transmitting substrate on which the plurality of thin-film transistors and the plurality of silicon photodiodes are formed, and a liquid crystal layer sealed between the first light-transmitting substrate and the second light-transmitting substrate,
wherein a diffraction grating is formed on a face of a photoreception portion of each of the silicon photodiodes, the face being on a second light-transmitting substrate side or on a side opposite the second light-transmitting substrate.

2. The liquid crystal panel according to claim 1,
wherein letting n1 be a refractive index of a first layer adjacent to the photoreception portion on the second light-transmitting substrate side, n2 be a refractive index of the photoreception portion, n3 be a refractive index of a second layer adjacent to the photoreception portion on the side opposite the second light-transmitting substrate, λ be a wavelength of a light beam incident from the first layer onto the photoreception portion, θ1 be an angle of incidence of the light beam incident from the first layer onto the photoreception portion, θ2 be an angle of emergence of diffracted light of the light beam exiting from the face on which the diffraction grating is formed into the photoreception portion, m be a diffraction order of the diffracted light, and d be a structural period of the diffraction grating, the structural period d is set such that
when |m|=1,
n2*sin θ2=n1*sin θ1+m*(λ/d),
θ2>arksin (n1/n2) and
θ2>arksin (n3/n2)
are satisfied.

3. The liquid crystal panel according to claim 2,
wherein the liquid crystal panel has a touch sensor face on a side of the second light-transmitting substrate opposite the first light-transmitting substrate, and
letting H be a gap between the photoreception portion and the touch sensor face, and W be a pixel pitch in a repeating direction of the periodic structure of the diffraction grating,
θ1<arktan (W/H)
is satisfied.

4. The liquid crystal panel according to claim 1,
wherein letting n1 be a refractive index of a first layer adjacent to the photoreception portion on the second light-transmitting substrate side, n2 be a refractive index of the photoreception portion, λ be a wavelength of a light beam incident from the first layer onto the photoreception portion, θ1 be an angle of incidence of the light beam incident from the first layer onto the photoreception portion, θ2 be an angle of emergence of diffracted light of the light beam exiting from the face on which the diffraction grating is formed into the photoreception portion, m be a diffraction order of the diffracted light, and d be a structural period of the diffraction grating,
when |m|>1,
n2*sin θ2=n1*sin θ1+m*(λ/d),
θ2>arksin (n1/n2), and
θ2>arksin (n3/n2)
are satisfied.
